(19) United States
(12) Patent Application Publication
(10) Pub. No.: US 2026/0150791 A1
(43) Pub. Date: Jun. 4, 2026

(54) METHOD FOR PRODUCING CONSUMER-READY VEGETABLES, MUSHROOMS OR HERBS IN A BOX

(71) Applicant: RIJK ZWAAN ZAADTEELT EN ZAADHANDEL B.V., De Lier (NL)

(72) Inventor: Thijs HULISZ, De Lier (NL)

(21) Appl. No.: 19/412,217

(22) Filed: Dec. 8, 2025

Related U.S. Application Data
(63) Continuation-in-part of application No. PCT/NL2024/050301, filed on Jun. 7, 2024.

(30) Foreign Application Priority Data
Jun. 7, 2023 (NL) 2035017

(51) Int. Cl. A01G 9/029; A01G 22/15; A01G 24/44

(52) U.S. Cl. CPC A01G 9/0293; A01G 22/15; A01G 24/44

(57) ABSTRACT

Methods of producing consumer-ready vegetables, mushrooms or herbs are provided. The method can include the steps of: a) culturing vegetables, mushrooms or herbs in a closed container under suitable growing conditions until maturity; and b) transferring the container with the mature vegetable, mushrooms or herb to a retail outlet, wherein the vegetables, mushrooms or herbs are cultured on a thin mat that rests on a number of protrusions extending from the bottom of the container into the inside of the container. Containers and sets for performing the methods as described herein are also provided.

### RELATED APPLICATIONS AND INCORPORATION BY REFERENCE

This application is a continuation-in-part application of international patent application Serial No. PCT/NL2024/050301 filed Jun. 7, 2024, which published as PCT Publication No. WO 2024/253532 A1 on Dec. 12, 2024, which claims benefit of Dutch patent application Serial No. 2035017 filed Jun. 7, 2023.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to a method for producing consumer-ready vegetables, mushrooms or herbs. The invention also relates to a container for use in the method and to a complete set for producing vegetables, mushrooms or herbs.

### BACKGROUND OF THE INVENTION

Vegetables, mushrooms and herbs are traditionally produced by specialized growers in greenhouses or on fields. After harvest, the produce needs to be transported to a retail outlet. The transportation costs have an impact on the final consumer price. Moreover, it is sometimes necessary to store the produce before it is distributed. For certain products this may require specialized storage facilities.

Citation or identification of any document in this application is not an admission that such document is available as prior art to the present invention.

### SUMMARY OF THE INVENTION

According to one aspect, the present invention provides a method for producing consumer-ready vegetables, mushrooms or herbs, comprising the step of:
culturing vegetables, mushrooms or herbs in a closed container under suitable growing conditions until maturity, characterized in that the vegetables, mushrooms or herbs are cultured on a thin mat that rests on a number of protrusions extending from the bottom of the container into the inside of the container.

More in particular, according to another aspect, the present invention provides a consumer-ready-to-be-consumed vegetable in a closed container that the consumer-ready-to-be-consumed vegetable was grown in, a consumer-ready-to-be-consumed herb in a closed container that the consumer-ready-to-be-consumed herb was grown in, or a consumer-ready-to-be-consumed mushroom, in a closed container that the consumer-ready-to-be-consumed herb was grown in, said consumer-ready-to-be-consumed vegetable in the closed container, said consumer-ready-to-be-consumed herb in the closed container, or consumer-ready-to-be-consumed mushroom in the closed container produced by a method comprising the steps of:
a) assembling in a container, materials for producing the consumer-ready-to-be-consumed vegetable in the closed container, the consumer-ready-to-be-consumed herb in the closed container, or the consumer-ready-to-be-consumed mushroom in the closed container comprising:
   i) a substrate comprising vegetable or herb seed, vegetable or herb germinated seed, vegetable or herb seedling, small vegetable or herb plant, or mycelium for mushrooms;
   ii) water for growth to the consumer-ready-to-be-consumed vegetable in the closed container, the consumer-ready-to-be-consumed herb in the closed container, or the consumer-ready-to-be-consumed mushroom in the closed container of the vegetable or herb seed, vegetable or herb germinated seed, vegetable or herb seedling, small vegetable or herb plant, or mycelium for mushrooms under suitable growing conditions, and
      wherein, said suitable conditions for growth to the consumer-ready-to-be-consumed vegetable in the closed container, the consumer-ready-to-be-consumed herb in the closed container, or the consumer-ready-to-be-consumed mushroom in the closed container of the vegetable or herb seed, vegetable or herb germinated seed, vegetable or herb seedling, small vegetable or herb plant, or mycelium for mushrooms comprise suitable light intensity and color for optimal growth to the consumer-ready-to-be-consumed vegetable in the closed container, the consumer-ready-to-be-consumed herb in the closed container, or the consumer-ready-to-be-consumed mushroom in the closed container;
      wherein the container defines a plurality of protrusions extending from the bottom of the inside of the container and the plurality of protrusions define ridges for holding water and nutrients;
      wherein the substrate comprising the vegetable or herb seed, vegetable or herb germinated seed, vegetable or herb seedling, small vegetable or herb plant, or mycelium for mushrooms is placed on an upper surface of the plurality of protrusions;
b) sealing the container with a permeable membrane to obtain a closed container containing the materials for producing the consumer-ready-to-be-consumed vegetable in the closed container, the consumer-ready-to-be-consumed herb in the closed container, or the consumer-ready-to-be-consumed mushroom in the closed container,
   wherein said membrane is permeable to oxygen and carbon dioxide and impermeable to contamination and pathogens, and
c) growing in the closed container at the place for growth the vegetable or herb seed, vegetable or herb germinated seed, vegetable or herb seedling, small vegetable or herb plant, or mycelium for mushrooms under the suitable growing conditions until the consumer-ready-to-be-consumed vegetable in the closed container, the consumer-ready-to-be-consumed herb in the closed container, or the consumer-ready-to-be-consumed mushroom in the closed container is produced,
   whereby the consumer-ready-to-be-consumed vegetable in the closed container, the consumer-ready-to-be-consumed herb in the closed container, or the consumer-ready-to-be-consumed mushroom in the closed container is produced.

In some embodiments of the consumer-ready-to-be-consumed vegetable, the consumer-ready-to-be-consumed herb, or the consumer-ready-to-be-consumed mushroom, the plurality of protrusions of the container used to produce the consumer-ready-to-be-consumed vegetable, the consumer-ready-to-be-consumed herb, or the consumer-ready-to-be-consumed mushroom are evenly distributed over the bottom of the container.

In some embodiments of the consumer-ready-to-be-consumed vegetable, the consumer-ready-to-be-consumed herb, or the consumer-ready-to-be-consumed mushroom, the plurality of protrusions of the container used to produce the consumer-ready-to-be-consumed vegetable, the consumer-ready-to-be-consumed herb, or the consumer-ready-to-be-consumed mushroom are randomly distributed over the bottom of the container.

In some embodiments of the consumer-ready-to-be-consumed vegetable, the consumer-ready-to-be-consumed herb, or the consumer-ready-to-be-consumed mushroom, the plurality of protrusions of the container used to produce the consumer-ready-to-be-consumed vegetable, the consumer-ready-to-be-consumed herb, or the consumer-ready-to-be-consumed mushroom have the form of pillars, spikes, pyramids, bulbs or spheres.

In some embodiments of the consumer-ready-to-be-consumed vegetable, the consumer-ready-to-be-consumed herb, or the consumer-ready-to-be-consumed mushroom, the plurality of protrusions of the container used to produce the consumer-ready-to-be-consumed vegetable, the consumer-ready-to-be-consumed herb, or the consumer-ready-to-be-consumed mushroom have a round, oval, square, or triangular cross-section.

In some embodiments of the consumer-ready-to-be-consumed vegetable, the consumer-ready-to-be-consumed herb, or the consumer-ready-to-be-consumed mushroom, the substrate comprising the vegetable or herb seed, vegetable or herb germinated seed, vegetable or herb seedling, small vegetable or herb plant, or mycelium for mushrooms for producing the consumer-ready-to-be-consumed vegetable, the consumer-ready-to-be-consumed herb, or the consumer-ready-to-be-consumed mushroom in steps a) i), ii), and c), is provided in the form of a seed mat or seed band.

In some embodiments of the consumer-ready-to-be-consumed vegetable, the consumer-ready-to-be-consumed herb, or the consumer-ready-to-be-consumed mushroom, the substrate is a seed mat and when said seed mat is placed in the container, the upper surface of the plurality of protrusions support the seed mat and the edges of the seed mat are in contact with the water in the container.

In some embodiments of the consumer-ready-to-be-consumed vegetable, the consumer-ready-to-be-consumed herb, or the consumer-ready-to-be-consumed mushroom, the consumer-ready-to-be-consumed vegetable is selected from leaf lettuce, head lettuce or baby leaf lettuce, endive, rucola, lamb lettuce, corn salad, chard, leaf beet, spinach, radish, cress, beet sprouts, alfalfa, broccoli sprouts, bean sprouts, fennel sprouts, cabbage sprouts, garlic sprouts, leek sprouts, pea sprouts, or chickpea sprouts; and
the herbs are selected from chives, parsley, basil, dill weed, coriander, cilantro, mint, oregano, rosemary, thyme, marjoram, lemon balm.

In some embodiments of the consumer-ready-to-be-consumed vegetable, the consumer-ready-to-be-consumed herb, or the consumer-ready-to-be-consumed mushroom, the method for producing the consumer-ready-to-be-consumed vegetable, the consumer-ready-to-be-consumed herb, or the consumer-ready-to-be-consumed mushroom comprises:
b1) applying a label with information regarding the consumer-ready-to-be-consumed vegetable in the closed container, the consumer-ready-to-be-consumed herb in the closed container, or the consumer-ready-to-be-consumed mushroom in the closed container;
   said applying occurring either prior to or after sealing the container with the permeable membrane.

In some embodiments of the consumer-ready-to-be-consumed vegetable, the consumer-ready-to-be-consumed herb, or the consumer-ready-to-be-consumed mushroom, the method for producing the consumer-ready-to-be-consumed vegetable, the consumer-ready-to-be-consumed herb, or the consumer-ready-to-be-consumed mushroom comprises:
b2) transferring the closed container containing the materials for producing the consumer-ready-to-be-consumed vegetable in the closed container, the consumer-ready-to-be-consumed herb in the closed container, or the consumer-ready-to-be-consumed mushroom in the closed container to a place for growth of the vegetable or herb seed, vegetable or herb germinated seed, vegetable or herb seedling, small vegetable or herb plant, or mycelium for mushrooms under the suitable growing conditions. In some embodiments, step b2) comprises transferring the closed container to a retail outlet.

In some embodiments of the consumer-ready-to-be-consumed vegetable, the consumer-ready-to-be-consumed herb, or the consumer-ready-to-be-consumed mushroom, the consumer-ready-to-be-consumed vegetable, the consumer-ready-to-be-consumed herb, or the consumer-ready-to-be-consumed mushroom is grown at a retail outlet or a regional facility of the retail outlet.

In another aspect, the present invention provides a container for producing a consumer-ready-to-be-consumed vegetable, a consumer-ready-to-be-consumed herb, or a consumer-ready-to-be-consumed mushroom comprising:
an open top; and
a bottom opposite the top;
wherein the bottom defines a plurality of protrusions extending into the interior of the container, the plurality of protrusions defining ridges for holding water and nutrients.

In some embodiments, the container is for use in the method for producing the consumer-ready-to-be-consumed vegetable, a consumer-ready-to-be-consumed herb, or a consumer-ready-to-be-consumed mushroom as described herein, and comprises a box with an open top and a bottom opposite the top that is provided with protrusions extending into the inside of the box and defining ridges for holding water and nutrients.

In some embodiments, the plurality of protrusions are evenly distributed over the bottom of the container.

In some embodiments, the plurality of protrusions are randomly distributed over the bottom of the container.

In some embodiments, the plurality of protrusions have the form of pillars, spikes, pyramids, bulbs, or spheres. In an advantageous embodiment, the plurality of productions have the form of pillars.

In some embodiments, the plurality of protrusions have a round, oval, square, or triangular cross-section.

In some embodiments, the bottom is configured to accept an insert, wherein the insert defines the plurality of protrusions.

In yet another aspect, the present invention provides a set for producing a consumer-ready-to-be-consumed vegetable in a closed container, a consumer-ready-to-be-consumed herb in a closed container, or a consumer-ready-to-be-consumed mushroom in a closed container, comprising:
a substrate comprising vegetable or herb seed, vegetable or herb germinated seed, vegetable or herb seedling, small vegetable or herb plant, or mycelium for mushrooms;
a container for containing the substrate comprising vegetable or herb seed, vegetable or herb germinated seed, vegetable or herb seedling, small vegetable or herb plant, or mycelium for mushrooms; and
a permeable membrane;
wherein the container comprises:
   an open top; and
   a bottom opposite the top;
   wherein the bottom defines a plurality of protrusions extending into the interior of the container, the plurality of protrusions defining ridges for holding water and nutrients; and
      wherein the container is configured to be closed or sealed by the permeable membrane.

In some embodiments of the set, the set for producing consumer-ready vegetables, mushrooms or herbs, comprises a container for containing the vegetables, mushrooms or herbs, sowing or planting material, a mat and a permeable membrane, wherein the bottom of the container is provided with protrusions extending into the inside of the container.

In some embodiment of the set, the container is the container as described herein.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112(a)) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 shows a conventional container with a seed mat placed on the bottom of the box.

FIG. 2 shows a perspective view of an empty container of the invention with protrusions having a pillar shape with an essentially square cross-section.

FIG. 3 shows a perspective view that is a close-up view on the protrusions of the container of FIG. 2.

FIG. 4 is a bottom view of the container containing a plantlet in which roots are formed in the ridges between each of the protrusions.

### DETAILED DESCRIPTION OF THE INVENTION

WO2014/056869, WO2017/125588, and U.S. application Ser. No. 13/792,022, Ser. No. 18/621,666, and Ser. No. 16/029,851 relate to the production of vegetables, herbs and mushrooms that leads to lower costs and a fresher product by way of a method for producing consumer-ready vegetables, mushrooms or herbs, wherein vegetables, mushrooms or herbs are cultured in a closed container under suitable growing conditions until maturity and the container with the mature vegetable, mushrooms or herb is transferred to a retail outlet. Culturing the vegetables, mushrooms and herbs can also take place at the premises of the retail outlet.

In these methods, the seeds are placed in the container and the container is closed with a permeable membrane, which is permeable to oxygen (O₂), carbon dioxide (CO₂) and water vapor but impermeable to contaminations and pathogens, such as viruses, bacteria, fungi, protists or insects.

Seeds can only germinate after contact with water and the germinated seeds and plants require water and nutrients for growth. Since the container is closed after sowing or planting the seeds, mycelium or plantlets, the container must contain a sufficient amount of water for the plants or mushrooms to reach maturity. To provide for water in order for the seeds to germinate and grow they usually lie on a substrate. The substrate, by capillary action provides water to the seeds, that are positioned above the initial water level.

For the consumer, ease of harvest is important. In addition, the harvested product is intended for consumption and must therefore be clean. This is not always the case as some substrates have the tendency to shed fibers that may then adhere to the plants, which is undesirable. The instant invention provides methods and apparatuses having a unique architecture which allows for the roots of the vegetables, mushrooms or herbs to form a strong network around the protrusions at the bottom of the container. Plants are thus also more strongly connected to the container, which reduces adhesion of the substrate to the plants, thereby improving the attractiveness and quality of consumer-ready-to-be-consumed vegetables, herbs, or mushrooms produced therein.

Accordingly, in one aspect, the present invention relates to provide an improved method for producing vegetables, mushrooms and herbs directly in consumer packaging.

In some embodiments, the method for producing consumer-ready vegetables, mushrooms or herbs, comprises the steps of:
a) culturing vegetables, mushrooms or herbs in a closed container under suitable growing conditions until maturity; and
b) transferring the container with the mature vegetable, mushrooms or herb to a retail outlet, characterized in that the vegetables, mushrooms or herbs are cultured in the container on a thin mat that rests on a number of protrusions extending from the bottom into the inside of the container.

More in particular, the present invention provides a consumer-ready-to-be-consumed vegetable in a closed container that the consumer-ready-to-be-consumed vegetable was grown in, a consumer-ready-to-be-consumed herb in a closed container that the consumer-ready-to-be-consumed herb was grown in, or a consumer-ready-to-be-consumed mushroom, in a closed container that the consumer-ready-to-be-consumed herb was grown in, said consumer-ready-to-be-consumed vegetable in the closed container, said consumer-ready-to-be-consumed herb in the closed container, or consumer-ready-to-be-consumed mushroom in the closed container produced by a method comprising the steps of:
a) assembling in a container, materials for producing the consumer-ready-to-be-consumed vegetable in the closed container, the consumer-ready-to-be-consumed herb in the closed container, or the consumer-ready-to-be-consumed mushroom in the closed container comprising:
   i) a substrate comprising vegetable or herb seed, vegetable or herb germinated seed, vegetable or herb seedling, small vegetable or herb plant, or mycelium for mushrooms;
   ii) water for growth to the consumer-ready-to-be-consumed vegetable in the closed container, the consumer-ready-to-be-consumed herb in the closed container, or the consumer-ready-to-be-consumed mushroom in the closed container of the vegetable or herb seed, vegetable or herb germinated seed, vegetable or herb seedling, small vegetable or herb plant, or mycelium for mushrooms under suitable growing conditions, and
      wherein, said suitable conditions for growth to the consumer-ready-to-be-consumed vegetable in the closed container, the consumer-ready-to-be-consumed herb in the closed container, or the consumer-ready-to-be-consumed mushroom in the closed container of the vegetable or herb seed, vegetable or herb germinated seed, vegetable or herb seedling, small vegetable or herb plant, or mycelium for mushrooms comprise suitable light intensity and color for optimal growth to the consumer-ready-to-be-consumed vegetable in the closed container, the consumer-ready-to-be-consumed herb in the closed container, or the consumer-ready-to-be-consumed mushroom in the closed container;
      wherein the container defines a plurality of protrusions extending from the bottom of the inside of the container and the plurality of protrusions define ridges for holding water and nutrients;
      wherein the substrate comprising the vegetable or herb seed, vegetable or herb germinated seed, vegetable or herb seedling, small vegetable or herb plant, or mycelium for mushrooms is placed on an upper surface of the plurality of protrusions;
b) sealing the container with a permeable membrane to obtain a closed container containing the materials for producing the consumer-ready-to-be-consumed vegetable in the closed container, the consumer-ready-to-be-consumed herb in the closed container, or the consumer-ready-to-be-consumed mushroom in the closed container,
   wherein said membrane is permeable to oxygen and carbon dioxide and impermeable to contamination and pathogens, and
c) growing in the closed container at the place for growth the vegetable or herb seed, vegetable or herb germinated seed, vegetable or herb seedling, small vegetable or herb plant, or mycelium for mushrooms under the suitable growing conditions until the consumer-ready-to-be-consumed vegetable in the closed container, the consumer-ready-to-be-consumed herb in the closed container, or the consumer-ready-to-be-consumed mushroom in the closed container is produced,
   whereby the consumer-ready-to-be-consumed vegetable in the closed container, the consumer-ready-to-be-consumed herb in the closed container, or the consumer-ready-to-be-consumed mushroom in the closed container is produced.

The method of the invention can be used for any type of produce, but in particular the vegetables are leafy vegetables, in particular lettuce, in particular leaf lettuce, head lettuce or baby leaf lettuce, endive, rucola, lamb lettuce, corn salad, chard, leaf beet, spinach, radish, sprout vegetables, in particular, cress, beet sprouts, alfalfa, broccoli sprouts, bean sprouts, fennel sprouts, cabbage sprouts, garlic sprouts, leek sprouts, pea sprouts, chickpea sprouts, or wherein the herbs are selected from chives, parsley, basil, dill weed, coriander, cilantro, mint, oregano, rosemary, thyme, marjoram, lemon balm.

The lettuce is for example leaf lettuce, head lettuce or baby leaf lettuce. For baby leaf lettuce different lettuce varieties may be used to obtain an attractive mixture. In one embodiment, two or more lettuce seeds of different varieties are used to obtain a mix of different leaf or head lettuce plants.

The herbs are for example selected from chives, parsley, basil, dill, coriander, cilantro, mint, oregano, rosemary, thyme, marjoram, lemon balm. In a particular embodiment, mixtures of herbs may be produced such as an Italian herb mix or French herb mix.

Mixtures of mushrooms may also be made by using different spores. The method may also be used for obtaining one large mushroom such as a Portobello mushroom.

Prior to culturing the vegetables, mushrooms or herbs, a seed, germinated seed, seedling or small plant for the vegetable or herb or mycelium for the mushrooms is placed in the plant compartment and the container is closed.

Before transfer to the supermarket shelf, the container is suitably provided with a label with information regarding the vegetable, mushrooms or herb. The label can be applied either prior to or after sealing the container with the permeable membrane.

In some embodiments, culturing of the vegetables, mushrooms or herbs until maturity takes suitably place in, or in the vicinity of, the retail outlet. Suitably the products are cultured in storage rooms or basements of the retail outlet. This way the transportation costs are saved. Moreover, the products need not be stored between harvest and transport to their point of sale and are therefore fresher. The retail outlet is suitably a supermarket, but other types of stores can be envisaged as well.

It is not necessary for the method of the invention to be performed in the retail outlet itself. It is also possible that the products are grown in regional facilities to supply multiple retail outlets in the area, thus still having part of the benefit of lower transportation costs.

The growth facilities are preferably provided with specialized lighting systems designed to provide the correct light intensity and color, in particular, well known assimilation lighting. Such systems may be automatically controlled to allow for a light and darkness cycle that is particularly adapted to the type of vegetable, mushroom or herb. Further, temperature as well humidity levels are preferably regulated carefully. Also the level of flow of air throughout the system is very relevant as well as the quality of the air that is applied. The air is preferably filtered in order to minimize the possibility of an infection.

To germinate, the seeds or spores need to be in contact with a fluid, such as water or a buffer. Suitably, closing the container is done after introducing the fluid into the container. Since the container remains unopened before the product is ready to be consumed, all nutrients and fluids needed to obtain a mature product are to be included in the container before closure thereof.

After sowing the seeds or spores or planting the germinated seeds, seedlings, plantlets or mycelium the container is closed with the membrane to be re-opened only by the consumer after the product is sold. Thus, the product itself does not require handling and remains much more hygienic.

In another aspect, the present invention provides a container for carrying out the method for producing the consumer-ready-to-be-consumed vegetable, the consumer-ready-to-be-consumed herb, or the consumer-ready-to-be-consumed mushroom as described herein.

In some embodiments, the container for producing the consumer-ready-to-be-consumed vegetable, the consumer-ready-to-be-consumed herb, or the consumer-ready-to-be-consumed mushroom comprises:
an open top; and
a bottom opposite the top;
wherein the bottom defines a plurality of protrusions extending into the interior of the container, the plurality of protrusions defining ridges for holding water and nutrients.

In some embodiments of the container for use in the methods described herein, the container comprises a box with an open top and a bottom opposite the top that is provided with protrusions extending into the inside of the box and defining ridges for holding water and nutrients.

In some embodiments, the container comprises a box with an open top and a bottom opposite the top that is provided with protrusions extending into the inside of the box and defining ridges for holding water and nutrients.

In some embodiments, the bottom of the container defines a plant compartment in which vegetables, mushrooms or herbs, seeds, germinated seeds, seedlings or small plants for the vegetables or herbs or mycelia for the mushrooms are placed prior to closing the container.

Both with respect to the methods described herein and the set or kit described herein, the size and form of the container preferably correspond with the size and form of the mature vegetable or herb or the quantity of mushrooms to be produced. The container may also have any other form as well. In some embodiments, the can be a square box, a rectangular box or a tube, or any other suitable form.

In some embodiments, the protrusions can have any suitable arrangement in the container. In some embodiments, the protrusions are evenly distributed over the bottom of the container. In some embodiments, the protrusions are randomly distributed over the bottom of the container.

In some embodiments, the protrusions define ridges for containing water and nutrients.

The protrusions may take any suitable shape or form, including, but not limited to the form of pillars, spikes, pyramids, bulbs or spheres. In an advantageous embodiment, the protrusions have a pillar shape.

In some embodiments, protrusions may have various cross-sections, including but not limited to a round, oval, square, or triangular cross-section. In an advantageous embodiment, the protrusions have a square cross-section.

In some embodiments of the container, the protrusions can be provided as an insert for placement into the container. This permits use of a conventional container for the method for producing consumer-ready vegetables, mushrooms or herbs as described herein and the insert forms support for a substrate to provide water to seeds by capillary action.

When in use, the protrusions support the substrate, which can, be, for example a seed mat as described further herein, and the edges of the seed mat are in contact with water in the container. This way, the water is transported via capillary action to the seeds or the young plants. Later on in the growth process, the roots have penetrated the seed mat and are in contact with the water in the container.

In some embodiments, means are provided for transporting water and nutrients to the vegetables, mushrooms and herbs are provided. The means are suitably capillary means that distribute water and nutrients to the seed or the roots of the growing plant. In some embodiments, such means are the substrate. Such means are preferably formed by a carrier, in particular a mat. The mat may already comprise the seeds or the seeds are placed on or in the mat. The structure of the mat is suitable for transport and distribution of water and nutrients via capillary action. The terms ‘mat’, ‘seed mat’ and ‘capillary mat’ are used interchangeably herein.

In some embodiments, the substrate is a seed mat or a seed band.

In an advantageous embodiment, the substrate is a seed mat. In this respect, a seed mat (also referred to as a seed cloth) is formed of any material that is suitable for growing plants from the seeds that are in the seed mat. Known materials that are used for such seed mats are fabric or paper or a combination thereof.

In another advantageous embodiment, the substrate on or in which the seeds rest, i.e. the seed mat, is made of a bio-based material. Suitable examples are VegBed™, Nygaia™ and the biodegradable fibers of Growcoon™. VegBed™ Microgreen Mats are a growing medium made from bamboo fibers. Nygaia™ is a product of Maan Biobased Products.

The advantage of such biodegradable mats is that they are very clean so that contamination of the produce with plastic fibers can be avoided.

In some embodiments, the seeds are preferably sterile and integrated in the mat to avoid floating away. Alternatively, the seeds are fixed to the mat by means of an adhesive or a glue. The water and nutrients are suitably formed by standard hydroponics water. However, more specific recipes can be applied in order to optimally facilitate the growth of the vegetables, mushrooms or herbs, using the method of the invention.

The container is closed off with a permeable membrane, which is preferably permeable to oxygen (O₂), carbon dioxide (CO₂), and water vapor but preferably impermeable to contaminations and pathogens, such as viruses, bacteria, fungi, protists or insects. Suitably, the closing membrane is at least partially self-adhesive, in particular at the edges. Alternatively, the closing membrane is sealed to the container by means of a heat sealer. The membrane can then be easily stuck to the open side of the container to seal it off. The products thus grow in a contamination-and pathogen-free environment. The resistance requirements for the products are much lower or even dispensable when compared to growing products in a greenhouse or on the field. Each plant or mushrooms is individually packed and cannot contaminate other plants or be contaminated. The retailer can thus use seeds that may comprise fewer resistances which as a consequence of the lower development costs is more cost-effective.

In yet another aspect, the present invention relates to a set or a kit for producing consumer-ready vegetables, mushrooms or herbs, comprising a container for containing the vegetables, mushrooms or herbs, sowing or planting material, a mat and a permeable membrane, wherein the bottom of the container is provided with protrusions extending into the inside of the container.

In another aspect, the present invention relates to a container comprising a vegetable, mushrooms or herb, obtainable by the methods as described herein.

Accordingly, the invention may be performed without the contribution of the grower. The retailer may buy seed directly from seed companies. Since one step in the chain is now no longer necessary the retailer may produce its own vegetables, mushrooms and herbs at a significantly lower cost.

Although the present invention and its advantages have been described in detail, it should be understood that various changes, substitutions and alterations can be made herein without departing from the spirit and scope of the invention as defined in the appended claims.

The present invention will be further illustrated in the following Examples which are given for illustration purposes only and are not intended to limit the invention in any way.

### EXAMPLES

### Example 1

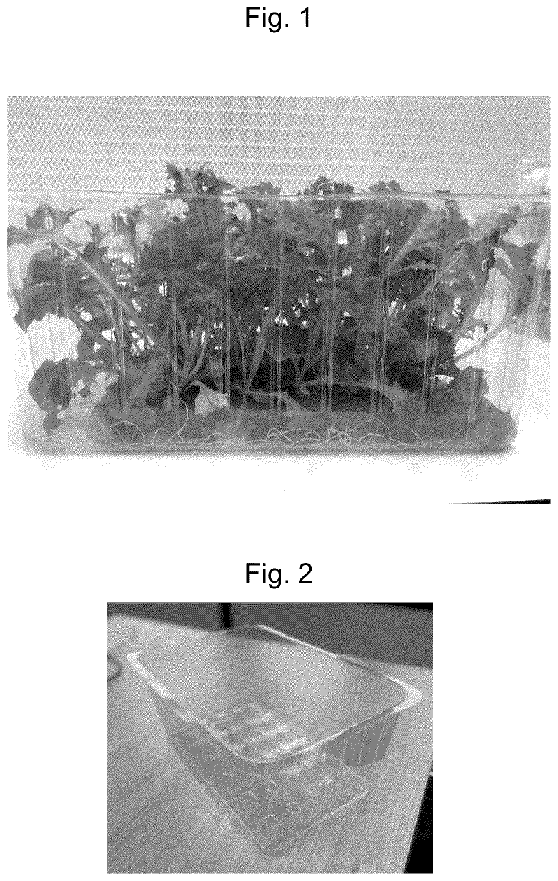

FIG. 1 provides an example of a leafy vegetable grown in the container as described herein according to the methods as described herein. As depicted in FIG. 1, the vegetable extends above a seed mat substrate and the roots of the vegetable extend below the seed mat and up the walls of the container. The seed mat sits atop a plurality of protrusions. does not extend the entire width of the container, thereby permitting the edge of seed mat to be in contact with water in the bottom of the container.

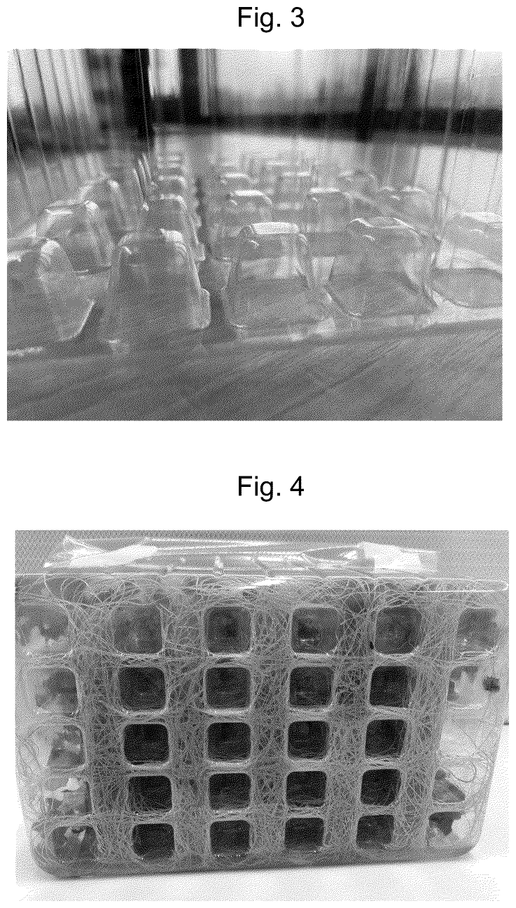

FIG. 2 shows an empty container having an open top and a bottom defining a plurality of protrusions that extend vertically into the interior space of the container. FIG. 3 provides a close up view of the protrusions, which define a series of ridges that can hold water or other materials dissolved in water such as nutrients and buffers.

In operation, the container is filled with a sufficient amount of water and nutrients to allow the plant or mushroom to be grown to reach maturity. The seed mat containing seeds of the vegetable or plant or mycelia of the mushroom to be grown is overlaid on the protrusions extending from the bottom of the container. Advantageously, the seed mat does not encompass the entire width of the container such that an edge of the seed mat can be continuously in contact with the water and nutrients, which can be taken up via capillary action. The container can then be sealed with a permeable membrane and transported to the facility where the plant or mushroom will grow to maturity under the requisite growing conditions for the particular plant or mushroom.

FIG. 4 shows the underlying root structure of the leafy vegetable depicted in FIG. 1 wherein the roots have penetrated the seed mat and are intertwined beneath the seed mat and within the space and ridges defined by the plurality of protrusions.

The invention is further described by the following numbered paragraphs:
1. A consumer-ready-to-be-consumed vegetable in a closed container that the consumer-ready-to-be-consumed vegetable was grown in, a consumer-ready-to-be-consumed herb in a closed container that the consumer-ready-to-be-consumed herb was grown in, or a consumer-ready-to-be-consumed mushroom, in a closed container that the consumer-ready-to-be-consumed herb was grown in, said consumer-ready-to-be-consumed vegetable in the closed container, said consumer-ready-to-be-consumed herb in the closed container, or consumer-ready-to-be-consumed mushroom in the closed container produced by a method comprising the steps of:
   a) assembling in a container, materials for producing the consumer-ready-to-be-consumed vegetable in the closed container, the consumer-ready-to-be-consumed herb in the closed container, or the consumer-ready-to-be-consumed mushroom in the closed container comprising:
      i) a substrate comprising vegetable or herb seed, vegetable or herb germinated seed, vegetable or herb seedling, small vegetable or herb plant, or mycelium for mushrooms;
      ii) water for growth to the consumer-ready-to-be-consumed vegetable in the closed container, the consumer-ready-to-be-consumed herb in the closed container, or the consumer-ready-to-be-consumed mushroom in the closed container of the vegetable or herb seed, vegetable or herb germinated seed, vegetable or herb seedling, small vegetable or herb plant, or mycelium for mushrooms under suitable growing conditions, and
         wherein, said suitable conditions for growth to the consumer-ready-to-be-consumed vegetable in the closed container, the consumer-ready-to-be-consumed herb in the closed container, or the consumer-ready-to-be-consumed mushroom in the closed container of the vegetable or herb seed, vegetable or herb germinated seed, vegetable or herb seedling, small vegetable or herb plant, or mycelium for mushrooms comprise suitable light intensity and color for optimal growth to the consumer-ready-to-be-consumed vegetable in the closed container, the consumer-ready-to-be-consumed herb in the closed container, or the consumer-ready-to-be-consumed mushroom in the closed container;
         wherein the container defines a plurality of protrusions extending from the bottom of the inside of the container and the plurality of protrusions define ridges for holding water and nutrients;
         wherein the substrate comprising the vegetable or herb seed, vegetable or herb germinated seed, vegetable or herb seedling, small vegetable or herb plant, or mycelium for mushrooms is placed on an upper surface of the plurality of protrusions;
   b) sealing the container with a permeable membrane to obtain a closed container containing the materials for producing the consumer-ready-to-be-consumed vegetable in the closed container, the consumer-ready-to-be-consumed herb in the closed container, or the consumer-ready-to-be-consumed mushroom in the closed container,
      wherein said membrane is permeable to oxygen and carbon dioxide and impermeable to contamination and pathogens, and
   c) growing in the closed container at the place for growth the vegetable or herb seed, vegetable or herb germinated seed, vegetable or herb seedling, small vegetable or herb plant, or mycelium for mushrooms under the suitable growing conditions until the consumer-ready-to-be-consumed vegetable in the closed container, the consumer-ready-to-be-consumed herb in the closed container, or the consumer-ready-to-be-consumed mushroom in the closed container is produced,
      whereby the consumer-ready-to-be-consumed vegetable in the closed container, the consumer-ready-to-be-consumed herb in the closed container, or the consumer-ready-to-be-consumed mushroom in the closed container is produced.
2. The consumer-ready-to-be-consumed vegetable, the consumer-ready-to-be-consumed herb, or the consumer-ready-to-be-consumed mushroom of paragraph 1, wherein the plurality of protrusions are evenly distributed over the bottom of the container.
3. The consumer-ready-to-be-consumed vegetable, the consumer-ready-to-be-consumed herb, or the consumer-ready-to-be-consumed mushroom of paragraph 1, wherein the plurality of protrusions are randomly distributed over the bottom of the container.
4. The consumer-ready-to-be-consumed vegetable, the consumer-ready-to-be-consumed herb, or the consumer-ready-to-be-consumed mushroom of paragraph 1, wherein the plurality of protrusions have the form of pillars, spikes, pyramids, bulbs or spheres.
5. The consumer-ready-to-be-consumed vegetable, the consumer-ready-to-be-consumed herb, or the consumer-ready-to-be-consumed mushroom of paragraph 1, wherein the plurality of protrusions have a round, oval, square, or triangular cross-section.
6. The consumer-ready-to-be-consumed vegetable, the consumer-ready-to-be-consumed herb, or the consumer-ready-to-be-consumed mushroom of paragraph 1, wherein the substrate comprising the vegetable or herb seed, vegetable or herb germinated seed, vegetable or herb seedling, small vegetable or herb plant, or mycelium for mushrooms for producing the consumer-ready-to-be-consumed vegetable, the consumer-ready-to-be-consumed herb, or the consumer-ready-to-be-consumed mushroom in steps a) i), ii), and c), is provided in the form of a seed mat or seed band.
7. The consumer-ready-to-be-consumed vegetable, the consumer-ready-to-be-consumed herb, or the consumer-ready-to-be-consumed mushroom of paragraph 1, wherein the substrate is a seed mat and when said seed mat is placed in the container, the upper surface of the plurality of protrusions support the seed mat and the edges of the seed mat are in contact with the water in the container.
8. The consumer-ready-to-be-consumed vegetable, the consumer-ready-to-be-consumed herb, or the consumer-ready-to-be-consumed mushroom of paragraph 1, wherein the consumer-ready-to-be-consumed vegetable is selected from leaf lettuce, head lettuce or baby leaf lettuce, endive, rucola, lamb lettuce, corn salad, chard, leaf beet, spinach, radish, cress, beet sprouts, alfalfa, broccoli sprouts, bean sprouts, fennel sprouts, cabbage sprouts, garlic sprouts, leek sprouts, pea sprouts, or chickpea sprouts; and
the herbs are selected from chives, parsley, basil, dill weed, coriander, cilantro, mint, oregano, rosemary, thyme, marjoram, lemon balm.
9. The consumer-ready-to-be-consumed vegetable, the consumer-ready-to-be-consumed herb, or the consumer-ready-to-be-consumed mushroom of paragraph 1, wherein the method for producing the consumer-ready-to-be-consumed vegetable, the consumer-ready-to-be-consumed herb, or the consumer-ready-to-be-consumed mushroom comprises:
   b1) applying a label with information regarding the consumer-ready-to-be-consumed vegetable in the closed container, the consumer-ready-to-be-consumed herb in the closed container, or the consumer-ready-to-be-consumed mushroom in the closed container;
      said applying occurring either prior to or after sealing the container with the permeable membrane.
10. The consumer-ready-to-be-consumed vegetable, the consumer-ready-to-be-consumed herb, or the consumer-ready-to-be-consumed mushroom of paragraph 1, wherein the method for producing the consumer-ready-to-be-consumed vegetable, the consumer-ready-to-be-consumed herb, or the consumer-ready-to-be-consumed mushroom further comprises:
b2) transferring the closed container containing the materials for producing the consumer-ready-to-be-consumed vegetable in the closed container, the consumer-ready-to-be-consumed herb in the closed container, or the consumer-ready-to-be-consumed mushroom in the closed container to a place for growth of the vegetable or herb seed, vegetable or herb germinated seed, vegetable or herb seedling, small vegetable or herb plant, or mycelium for mushrooms under the suitable growing conditions.
11. The consumer-ready-to-be-consumed vegetable, the consumer-ready-to-be-consumed herb, or the consumer-ready-to-be-consumed mushroom of paragraph 1, wherein the consumer-ready-to-be-consumed vegetable, the consumer-ready-to-be-consumed herb, or the consumer-ready-to-be-consumed mushroom is grown at a retail outlet or a regional facility of the retail outlet.
12. A container for producing a consumer-ready-to-be-consumed vegetable, a consumer-ready-to-be-consumed herb, or a consumer-ready-to-be-consumed mushroom comprising:
an open top; and
a bottom opposite the top;
wherein the bottom defines a plurality of protrusions extending into the interior of the container, the plurality of protrusions defining ridges for holding water and nutrients.
13. The container of paragraph 12, wherein the plurality of protrusions are evenly distributed over the bottom of the container.
14. The container of paragraph 12, wherein the plurality of protrusions are randomly distributed over the bottom of the container.
15. The container of paragraph 12, wherein the plurality of protrusions have the form of pillars, spikes, pyramids, bulbs, or spheres.
16. The container of paragraph 15, wherein the plurality of productions have the form of pillars.
17. The container of paragraph 12, wherein the plurality of protrusions have a round, oval, square, or triangular cross-section.
18. The container of paragraph 12, wherein the bottom is configured to accept an insert, wherein the insert defines the plurality of protrusions.
19. A set for producing a consumer-ready-to-be-consumed vegetable in a closed container, a consumer-ready-to-be-consumed herb in a closed container, or a consumer-ready-to-be-consumed mushroom in a closed container, comprising:
a substrate comprising vegetable or herb seed, vegetable or herb germinated seed, vegetable or herb seedling, small vegetable or herb plant, or mycelium for mushrooms;
a container for containing the substrate comprising vegetable or herb seed, vegetable or herb germinated seed, vegetable or herb seedling, small vegetable or herb plant, or mycelium for mushrooms; and
a permeable membrane;
wherein the container comprises:
   an open top; and
   a bottom opposite the top;
   wherein the bottom defines a plurality of protrusions extending into the interior of the container, the plurality of protrusions defining ridges for holding water and nutrients; and
wherein the container is configured to be closed or sealed by the permeable membrane.
20. The set of paragraph 19, wherein the substrate is provided in the form of a seed mat or seed band.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A consumer-ready-to-be-consumed vegetable in a closed container that the consumer-ready-to-be-consumed vegetable was grown in, a consumer-ready-to-be-consumed herb in a closed container that the consumer-ready-to-be-consumed herb was grown in, or a consumer-ready-to-be-consumed mushroom, in a closed container that the consumer-ready-to-be-consumed herb was grown in, said consumer-ready-to-be-consumed vegetable in the closed container, said consumer-ready-to-be-consumed herb in the closed container, or consumer-ready-to-be-consumed mushroom in the closed container produced by a method comprising the steps of:
a) assembling in a container, materials for producing the consumer-ready-to-be-consumed vegetable in the closed container, the consumer-ready-to-be-consumed herb in the closed container, or the consumer-ready-to-be-consumed mushroom in the closed container comprising:
i) a substrate comprising vegetable or herb seed, vegetable or herb germinated seed, vegetable or herb seedling, small vegetable or herb plant, or mycelium for mushrooms;
ii) water for growth to the consumer-ready-to-be-consumed vegetable in the closed container, the consumer-ready-to-be-consumed herb in the closed container, or the consumer-ready-to-be-consumed mushroom in the closed container of the vegetable or herb seed, vegetable or herb germinated seed, vegetable or herb seedling, small vegetable or herb plant, or mycelium for mushrooms under suitable growing conditions, and
wherein, said suitable conditions for growth to the consumer-ready-to-be-consumed vegetable in the closed container, the consumer-ready-to-be-consumed herb in the closed container, or the consumer-ready-to-be-consumed mushroom in the closed container of the vegetable or herb seed, vegetable or herb germinated seed, vegetable or herb seedling, small vegetable or herb plant, or mycelium for mushrooms comprise suitable light intensity and color for optimal growth to the consumer-ready-to-be-consumed vegetable in the closed container, the consumer-ready-to-be-consumed herb in the closed container, or the consumer-ready-to-be-consumed mushroom in the closed container;
wherein the container defines a plurality of protrusions extending from the bottom of the inside of the container and the plurality of protrusions define ridges for holding water and nutrients;
wherein the substrate comprising the vegetable or herb seed, vegetable or herb germinated seed, vegetable or herb seedling, small vegetable or herb plant, or mycelium for mushrooms is placed on an upper surface of the plurality of protrusions;
b) sealing the container with a permeable membrane to obtain a closed container containing the materials for producing the consumer-ready-to-be-consumed vegetable in the closed container, the consumer-ready-to-be-consumed herb in the closed container, or the consumer-ready-to-be-consumed mushroom in the closed container,
wherein said membrane is permeable to oxygen and carbon dioxide and impermeable to contamination and pathogens, and
c) growing in the closed container at the place for growth the vegetable or herb seed, vegetable or herb germinated seed, vegetable or herb seedling, small vegetable or herb plant, or mycelium for mushrooms under the suitable growing conditions until the consumer-ready-to-be-consumed vegetable in the closed container, the consumer-ready-to-be-consumed herb in the closed container, or the consumer-ready-to-be-consumed mushroom in the closed container is produced,
whereby the consumer-ready-to-be-consumed vegetable in the closed container, the consumer-ready-to-be-consumed herb in the closed container, or the consumer-ready-to-be-consumed mushroom in the closed container is produced.

2. The consumer-ready-to-be-consumed vegetable, the consumer-ready-to-be-consumed herb, or the consumer-ready-to-be-consumed mushroom of claim 1, wherein the plurality of protrusions are evenly distributed over the bottom of the container.

3. The consumer-ready-to-be-consumed vegetable, the consumer-ready-to-be-consumed herb, or the consumer-ready-to-be-consumed mushroom of claim 1, wherein the plurality of protrusions are randomly distributed over the bottom of the container.

4. The consumer-ready-to-be-consumed vegetable, the consumer-ready-to-be-consumed herb, or the consumer-ready-to-be-consumed mushroom of claim 1, wherein the plurality of protrusions have the form of pillars, spikes, pyramids, bulbs or spheres.

5. The consumer-ready-to-be-consumed vegetable, the consumer-ready-to-be-consumed herb, or the consumer-ready-to-be-consumed mushroom of claim 1, wherein the plurality of protrusions have a round, oval, square, or triangular cross-section.

6. The consumer-ready-to-be-consumed vegetable, the consumer-ready-to-be-consumed herb, or the consumer-ready-to-be-consumed mushroom of claim 1, wherein the substrate comprising the vegetable or herb seed, vegetable or herb germinated seed, vegetable or herb seedling, small vegetable or herb plant, or mycelium for mushrooms for producing the consumer-ready-to-be-consumed vegetable, the consumer-ready-to-be-consumed herb, or the consumer-ready-to-be-consumed mushroom in steps a) i), ii), and c), is provided in the form of a seed mat or seed band.

7. The consumer-ready-to-be-consumed vegetable, the consumer-ready-to-be-consumed herb, or the consumer-ready-to-be-consumed mushroom of claim 1, wherein the substrate is a seed mat and when said seed mat is placed in the container, the upper surface of the plurality of protrusions support the seed mat and the edges of the seed mat are in contact with the water in the container.

8. The consumer-ready-to-be-consumed vegetable, the consumer-ready-to-be-consumed herb, or the consumer-ready-to-be-consumed mushroom of claim 1, wherein the consumer-ready-to-be-consumed vegetable is selected from leaf lettuce, head lettuce or baby leaf lettuce, endive, rucola, lamb lettuce, corn salad, chard, leaf beet, spinach, radish, cress, beet sprouts, alfalfa, broccoli sprouts, bean sprouts, fennel sprouts, cabbage sprouts, garlic sprouts, leek sprouts, pea sprouts, or chickpea sprouts; and
the herbs are selected from chives, parsley, basil, dill weed, coriander, cilantro, mint, oregano, rosemary, thyme, marjoram, lemon balm.

9. The consumer-ready-to-be-consumed vegetable, the consumer-ready-to-be-consumed herb, or the consumer-ready-to-be-consumed mushroom of claim 1, wherein the method for producing the consumer-ready-to-be-consumed vegetable, the consumer-ready-to-be-consumed herb, or the consumer-ready-to-be-consumed mushroom comprises:
b1) applying a label with information regarding the consumer-ready-to-be-consumed vegetable in the closed container, the consumer-ready-to-be-consumed herb in the closed container, or the consumer-ready-to-be-consumed mushroom in the closed container;
said applying occurring either prior to or after sealing the container with the permeable membrane.

10. The consumer-ready-to-be-consumed vegetable, the consumer-ready-to-be-consumed herb, or the consumer-ready-to-be-consumed mushroom of claim 1, wherein the method for producing the consumer-ready-to-be-consumed vegetable, the consumer-ready-to-be-consumed herb, or the consumer-ready-to-be-consumed mushroom further comprises:
b2) transferring the closed container containing the materials for producing the consumer-ready-to-be-consumed vegetable in the closed container, the consumer-ready-to-be-consumed herb in the closed container, or the consumer-ready-to-be-consumed mushroom in the closed container to a place for growth of the vegetable or herb seed, vegetable or herb germinated seed, vegetable or herb seedling, small vegetable or herb plant, or mycelium for mushrooms under the suitable growing conditions.

11. The consumer-ready-to-be-consumed vegetable, the consumer-ready-to-be-consumed herb, or the consumer-ready-to-be-consumed mushroom of claim 1, wherein the consumer-ready-to-be-consumed vegetable, the consumer-ready-to-be-consumed herb, or the consumer-ready-to-be-consumed mushroom is grown at a retail outlet or a regional facility of the retail outlet.

12. A container for producing a consumer-ready-to-be-consumed vegetable, a consumer-ready-to-be-consumed herb, or a consumer-ready-to-be-consumed mushroom comprising:
an open top; and
a bottom opposite the top;
wherein the bottom comprises a plurality of protrusions extending into the interior of the container, the plurality of protrusions defining ridges for holding water and nutrients.

13. The container of claim 12, wherein the plurality of protrusions are evenly distributed over the bottom of the container.

14. The container of claim 12, wherein the plurality of protrusions are randomly distributed over the bottom of the container.

15. The container of claim 12, wherein the plurality of protrusions have the form of pillars, spikes, pyramids, bulbs, or spheres.

16. The container of claim 15, wherein the plurality of productions have the form of pillars.

17. The container of claim 12, wherein the plurality of protrusions have a round, oval, square, or triangular cross-section.

18. The container of claim 12, wherein the bottom is configured to accept an insert, wherein the insert defines the plurality of protrusions.

19. A set for producing a consumer-ready-to-be-consumed vegetable in a closed container, a consumer-ready-to-be-consumed herb in a closed container, or a consumer-ready-to-be-consumed mushroom in a closed container, comprising:
a substrate comprising vegetable or herb seed, vegetable or herb germinated seed, vegetable or herb seedling, small vegetable or herb plant, or mycelium for mushrooms;
a container for containing the substrate comprising vegetable or herb seed, vegetable or herb germinated seed, vegetable or herb seedling, small vegetable or herb plant, or mycelium for mushrooms; and
a permeable membrane;
wherein the container comprises:
an open top; and
a bottom opposite the top;
wherein the bottom defines a plurality of protrusions extending into the interior of the container, the plurality of protrusions defining ridges for holding water and nutrients; and
wherein the container is configured to be closed or sealed by the permeable membrane.

20. The set of claim 19, wherein the substrate is provided in the form of a seed mat or seed band.
